(19) United States
(12) Patent Application Publication
(10) Pub. No.: US 2015/0125528 A1
(43) Pub. Date: May 7, 2015

(54) CONTROLLED RELEASE APPARATUS AND USES THEREOF

(71) Applicant: The Water Initiative, LLC, Norwalk, CT (US)

(72) Inventors: Thomas A. Langdo, Cambridge, MA (US); Eugene A. Fitzgerald, Windham, NH (US); Richard Renjilian, Gurnee, IL (US); Larry R. Brown, Newton, MA (US); Robert S. Langer, Newton, MA (US)

(21) Appl. No.: 14/370,584

(22) PCT Filed: Jan. 4, 2013
(86) PCT No.: PCT/US2013/020321

§ 371 Date: Jul. 3, 2014

Related U.S. Application Data
(60) Provisional application No. 61/583,776, filed on Jan. 6, 2012.

(51) Int. Cl. C02F 1/76; A01N 59/08; C02F 1/68; A01N 25/34

(52) U.S. Cl. CPC C02F 1/76; A01N 25/34; A01N 59/08; C02F 1/68; C02F 2303/04; C02F 2305/02
USPC 424/484; 424/678; 424/486

(57) ABSTRACT

An apparatus is provided comprising one or more matrices contained within a shell, wherein the one or more matrices comprise between 1-99 wt % of a water-insoluble host material and between 1-99 wt % of a guest substrate, wherein the guest substrate comprises between 1-100 wt % of one or more disinfectant compounds or one or more beneficial compounds; and wherein the shell comprises a water-insoluble shell polymer, and one or more apertures. The host material may be a polymer. The apparatus is used for treating an aqueous medium with one or more disinfectant compounds or one or more beneficial compounds.

### CROSS REFERENCE TO RELATED APPLICATIONS

The present application claims priority to U.S. Provisional Application No. 61/583,776, filed Jan. 6, 2012, which application is incorporated herein by reference in its entirety.

### BACKGROUND

Conventional methods for the treatment of drinking water include the addition of chemical additives, such as chemical disinfectants, followed by close monitoring and adjustment of the concentration of the chemical additives in the treated water supply. Common disinfectants include halogen containing compounds such as chlorine gas or sodium hypochlorite. In industrial settings, such as centralized water treatment facilities, chlorine containing compounds are added to water supplies using mechanical dosage pumps. Chlorine levels are then continuously monitored and the compound dosage is continuously adjusted to maintain effective chlorine levels in the water supply. Such chemicals, infrastructure, and oversight are not practical in many ‘point-of-use’ (POU) settings that require drinking water to be treated just prior to being consumed. Point-of-use settings range from rural water sources that lack a centralized water treatment facility to the small-scale filtered pitchers and faucet attachments used at home and in the office.

Existing point-of-use systems suffer from several drawbacks. For example, point-of-use systems do not effectively provide a controlled release of chemical additives, such as disinfectants, into the treated water supply. Rather, point-of-use systems add variable and unreliable concentrations of chemical additives to water. Further, such point-of-use systems for the treatment of water generally do not indicate whether or not the water is being adequately treated. Often, these systems remain in use after the system has ceased to effectively treat the water because these systems lack indicators to alert the user when the system should be replaced.

Thus, a need exists for an improved point-of-use systems that will automatically treat a water supply with a controlled release of chemical additives.

### SUMMARY

Described herein is a point-of-use apparatus that efficiently and effectively treats a water supply with a controlled release of chemical additives. The point-of-use apparatus can be used to provide a controlled-release of beneficial or desirable molecules over time to water in point-of-use applications, such as consumer appliances, water filtration systems, and humanitarian applications such as disaster relief. The controlled-release apparatus can be used to release beneficial molecules such as disinfection compounds, vitamins, pharmaceuticals, minerals, and herbal extracts. The controlled-release apparatus is compatible with relatively small-scale and large-scale applications.

The apparatus provides controlled release solutions that are particularly beneficial in applications which require accurate dosing of the released molecule for desired efficacy. Such applications are frequently found in health related applications such as the release of vitamins, pharmaceuticals, minerals, and disinfection compounds. The apparatus employs a matrix that stores and delivers the beneficial compound(s) to a water supply at a controlled rate without user intervention. Further, the apparatus can be reduced to a small size and a flexible form.

In one aspect, an apparatus is provided comprising one or more matrices contained within a shell, wherein the one or more matrices comprise between 1-99 wt % of a water-insoluble host material and between 1-99 wt % of a guest substrate, wherein the guest substrate comprises between 1-100 wt % of one or more disinfectant compounds; and wherein the shell comprises a water-insoluble shell polymer, and one or more apertures. In some embodiments, the host material is a host polymer.

In another aspect, an apparatus is provided comprising one or more matrices contained within a shell, wherein the one or more matrices comprise between 1-99 wt % of a water-insoluble host material and between 1-99 wt % of a guest substrate, wherein the guest substrate comprises between 1-100 wt % of one or more beneficial compounds; and wherein the shell comprises a water-insoluble shell polymer, and one or more apertures. In some embodiments, the host material is a host polymer.

Another aspect provides a method of treating an aqueous medium with one or more disinfectant compounds or one or more beneficial compounds, the method comprising: contacting the apparatus of any one of the above embodiments with the aqueous medium; and allowing the one or more disinfectant compounds or one or more beneficial compounds to diffuse into the aqueous medium, thereby increasing the concentration of the one or more disinfectant compounds or one or more beneficial compounds in the aqueous medium.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein, that also may appear in any disclosure incorporated by reference, should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a cross section of an apparatus. A is an aperture, B is the shell polymer, C is the host polymer, and D is the guest substrate material.

FIG. 2 illustrates calcium hypochlorite stability temperature data. Below approximately 120° C., calcium hypochlorite maintains its free chlorine concentration during a 15 minute exposure to this temperature.

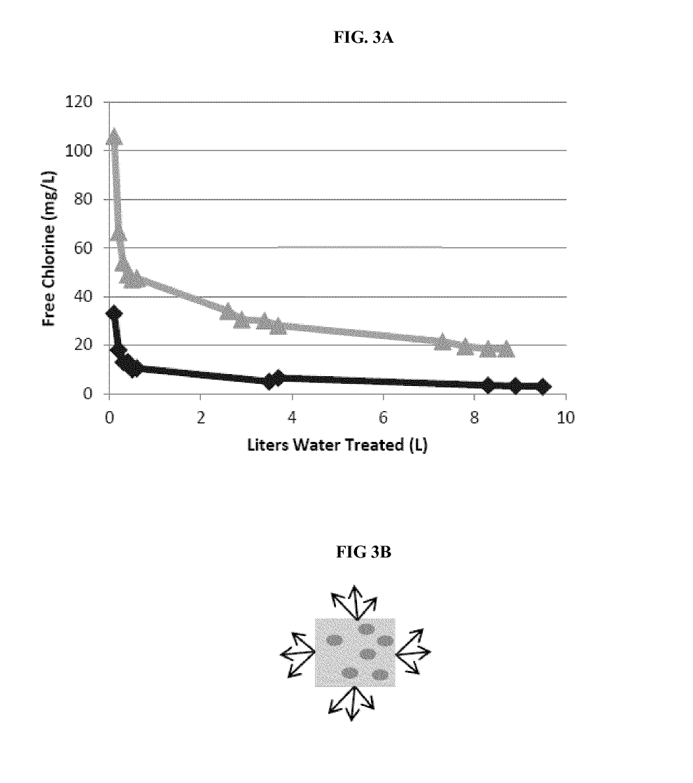

FIG. 3A illustrates that matrices fabricated using EVA and calcium hypochlorite, but without a shell polymer and apertures, demonstrated non constant, diffusion-limited release of the calcium hypochlorite.

60% Loading Blanket Film (diamonds; line closest to the x-axis);

80% Loading Blanket Film (triangles; line farthest from the x-axis)

FIG. 3B illustrates an apparatus without a shell polymer or apertures.

FIG. 4A illustrates that matrices that were coated by a shell polymer having apertures resulted in the constant release of free chlorine (from calcium hypochlorite) versus exposure to water.

60% Loading 3 Aperture (diamonds; line closest to the x-axis);

80% Loading 3 Aperture (triangles; line farthest from the x-axis)

FIG. 4B illustrates an apparatus with a shell polymer and apertures.

FIG. 4C displays an apparatus having three apertures, as indicated by the arrows.

FIG. 5 illustrates the non-constant and diffusion-limited release of calcium hypochlorite by six matrices without a shell polymer or apertures. Two different calcium hypochlorite chlorine source particle sizes (less than 105 microns, and between 500 to 1000 microns) and three weight fractions (40%, 60%, and 80%) were used in an EVA matrix. Release of calcium hypochlorite was non-constant for all six matrices as indicated by the curved line over the testing time.
A0 40% load <105 μm (diamonds; closest line to the x-axis);
B0 60% load <105 μm (squares; second line from the x-axis);
C0 80% load <105 μm (triangles; fifth line from the x-axis);
E0 40% load 500-1000 μm (X; third line from the x-axis);
F0 60% load 500-1000 μm (*; fourth line from the x-axis);
G0 80% load 500-1000 μm (circles, sixth line from the x-axis).

FIG. 6 illustrates the controlled release of calcium hypochlorite by four matrices with a shell polymer and three apertures. Two different calcium hypochlorite chlorine source particle sizes (less than 105 microns, and between 500 to 1000 microns) and two weight fractions (60% and 80%) were used in an EVA matrix surrounded by shell polymers having three apertures. Release of calcium hypochlorite was constant for all four matrices as indicated by the straight line over the testing time.
B4 60% load <105 μm triple aperture (squares; closest line to the x-axis);
C4 80% load <105 μm triple aperture (triangles; second line from the x-axis);
F4 60% load 500-1000 μm triple aperture (*; third line from the x-axis);
G3 80% load 500-1000 μm triple aperture (circles, fourth line from the x-axis).

FIG. 7 the controlled release of calcium hypochlorite by four matrices with a shell polymer and a single aperture. The remaining conditions were the same as those in FIG. 6.
B2 60% load <105 μm single aperture (squares; closest line to the x-axis);
C2 80% load <105 μm single aperture (triangles; second line from the x-axis);
F2 60% load 500-1000 μm single aperture (*; third line from the x-axis);
G1 80% load 500-1000 μm single aperture (circles, fourth line from the x-axis).

FIG. 8 illustrates restart data for matrices containing calcium hypochlorite and a polymer shell with apertures. The apparatus was tested for release of the calcium hypochlorite every 15 minutes and then the apparatus was dried out in a desiccator for one week. After drying, the apparatus was tested again for release every 15 minutes and the data was plotted as shown. Consistent and constant release was achieved prior to drying as indicated in release data plotted with negative measurement passes, and lower release levels were achieved after drying for measurement passes >0.
B4 60% loading 5 aperture <105 μm particle size (eleven diamonds farthest from the x-axis);
H4 60% loading 5 aperture <105 μm particle size (eleven diamonds closest to the x-axis);
C4 80% loading 5 aperture <105 μm particle size (ten triangles).

The features and advantages of the inventive embodiments will become more apparent from the detailed description set forth below when taken in conjunction with the drawings.

### DETAILED DESCRIPTION

### Point-of-Use Apparatus

In one aspect, an apparatus is provided comprising one or more matrices contained within a shell, wherein the one or more matrices comprise between 1-99 wt % of a water-insoluble host material and between 1-99 wt % of a guest substrate, wherein the guest substrate comprises between 1-100 wt % of one or more disinfectant compounds; and wherein the shell comprises a water-insoluble shell polymer, and one or more apertures. In some embodiments, the host material is a host polymer. In other embodiments, the host material is an insoluble inorganic material such as calcium carbonate.

In some embodiments, each matrix comprises between 10 wt % and 90 wt % of the guest substrate, and the guest substrate comprises between 1% to 100% of one or more disinfectant compounds. In other embodiments, each matrix comprises between 40 wt % and 80 wt % of the guest substrate, and the guest substrate comprises between 1% to 100% of one or more disinfectant compounds.

Generally, disinfection compounds can be halogen-containing compounds, comprising chlorine, bromine, and/or iodine groups. In some embodiments, the one or more disinfectant compounds comprise a halogen source compound. In other embodiments, the halogen source compound is selected from the group consisting of calcium hypochlorite, sodium hypochlorite, trichloroisocyanuric acid, sodium dichloroisocyanurate, 1,3-dibromo-5,5-dimethylhydantoin (DBDMH), and 1-bromo-3-chloro-5,5-dimethylimidazolidine-2,4-dione (BCDMH) or an iodine salt such as potassium iodide. In some embodiments, the halogen source compound is calcium hypochlorite.

In another aspect, an apparatus is provided comprising one or more matrices contained within a shell, wherein the one or more matrices comprise between 1-99 wt % of a water-insoluble host material and between 1-99 wt % of a guest substrate, wherein the guest substrate comprises between 1-100 wt % of one or more beneficial compounds; and wherein the shell comprises a water-insoluble shell polymer, and one or more apertures. In some embodiments, the host material is a host polymer. In some embodiments, the one or more beneficial compounds comprises a vitamin. Non-limiting examples of vitamins include Vitamin A, Vitamin C, Vitamin D, Vitamin K, Vitamin E, Thiamin, Riboflavin, Niacin, Vitamin B₆, and Vitamin B₁₂. In other embodiments, the one or more beneficial compounds comprises a pharmaceutical. In some embodiments, the one or more beneficial compounds comprises a mineral. Non-limiting examples of minerals include calcium, iron, fluorine, phosphorus, potassium, molybdenum, nickel, vanadium, tin, iodine, magnesium, selenium, chromium, manganese, copper, and zinc.

In some embodiments, each matrix comprises from about 10 wt % to about 90 wt % of the guest substrate, and the guest substrate comprises from about 1% to 100% of one or more mineral compounds or salts. In other embodiments, each matrix comprises from about 40 wt % to about 80 wt % of the guest substrate, and the guest substrate comprises from about 1% to 100% of one or more water soluble mineral compounds or salts. For example, the fluoride ion is beneficial to dental health within a window of from about 0.1 mg/L to about 4 mg/L, or from about 0.5 to about 1 mg/L, as recommended by the World Health Organization (WHO). An apparatus can be created using one of the common fluoride salts such as sodium fluoride (NaF) or sodium fluorosilicate (Na₂SiF₆) as the guest substrate to controllably release about 0.1 mg/L to about 4 mg/L fluoride into drinking water.

In some embodiments, the one or more beneficial compounds are selected from the group consisting of a vitamin, mineral, flavoring, herbal extract, and pharmaceutical. In some embodiments, the one or more beneficial compounds comprises a vitamin. In other embodiments, the one or more beneficial compounds comprises a pharmaceutical.

In some embodiments, the apparatus includes one or more matrices having a polymeric water-insoluble host material and a guest substrate, such as a disinfection compound. In some embodiments, the one or more matrices are homogenous, meaning that the polymeric water-insoluble host material and the guest substrate, such as a disinfection compound, are homogeneously distributed throughout the one or more matrices. For example, the distributed disinfection compound particles can form channels in the polymeric water-insoluble host material. In some embodiments, such disinfection compound particles range from 1 to 1000 microns in diameter. In some embodiments, such disinfection compound particles range from 10 to 600 microns. Release of the guest substrate, such as the disinfection compound particles, occurs by water driven dissolution of the guest substrate, resulting in a three dimensional network of open channels in the one or more matrices. The process continues as additional guest substrate dissolves in water, expanding the open channel network until all of the guest substrate has been dissolved and released from the one or more matrices, and out of the apparatus, exhausting the guest substrate. As noted, the water-insoluble host material exhibits little or no solubility in water. Thus, water flows substantially around, rather than through, the water-insoluble host material.

In some embodiments, the apparatus further comprises an aqueous medium. In other embodiments, the aqueous medium enters the apparatus through the one or more apertures, contacts the one or more matrices, and exits the apparatus through the one or more apertures. In some embodiments, the aqueous medium that exits the apparatus comprises the guest substrate at a concentration of between 0.0001 mg/L and 500 mg/L. In other embodiments, the concentration of the guest substrate in the aqueous medium that exits the apparatus can be controlled by the quantity and/or the diameter of the one or more apertures.

In some embodiments, the aqueous medium that exits the apparatus comprises the disinfectant compound at a concentration of between 0.2 mg/L and 10 mg/L. In other embodiments, the aqueous medium that exits the apparatus comprises the disinfectant compound at a concentration of between 0.5 mg/L and 4 mg/L. In some embodiments, the aqueous medium that exits the apparatus comprises the beneficial compound at a concentration of between 0.01 mg/L and 100 mg/L. In other embodiments, the aqueous medium that exits the apparatus comprises the beneficial compound at a concentration of between 0.1 mg/L and 10 mg/L.

In some embodiments, the one or more apertures are sealed with a hydrophilic polymer. In other embodiments, the hydrophilic polymer comprises a hydrogel. In some embodiments, the hydrogel is polyhydroxyethylmethacrylate.

In some embodiments, the host polymer and the shell polymer are independently selected from ethylene vinyl acetate (EVA), polyvinyl alcohol, silicone rubber, polyethylene, polypropylene, polystyrene (PS), polyester (PE), and copolymers thereof. In other embodiments, the host polymer and the shell polymer are the same. In some embodiments, the host polymer and the shell polymer are different.

In some embodiments, the shell has a thickness of between 1 and 500 microns. In other embodiments, the shell has a thickness of between 1 and 100 microns.

In some embodiments, the host polymer and the shell polymer are injection moldable. In other embodiments, the host polymer comprises ethylene vinyl acetate (EVA). In some embodiments, the shell polymer comprises ethylene vinyl acetate (EVA). In other embodiments, the ethylene vinyl acetate (EVA) is Celanese 4030AC, Arkema Evatane 4055, or DuPont Elvax 40W.

In some embodiments, the polymer is inert with respect to the guest substrate, i.e., it does not appreciably react or degrade the guest substrate. In other embodiments, the polymer is food contact grade. Further, the fabrication parameters, such as fabrication temperature, used to create the one or more matrices, should be chosen to minimize degradation of the guest substrate, and the additive compounds therein. In some embodiments, the polymer has a lower solubility in water than that of the guest substrate, or the additive compounds therein, so that some channel structures are formed within the one or more matrices.

In some embodiments, the polymer is ethylene vinyl acetate (EVA) with a 40% vinyl acetate (VA) weight fraction and the chlorine source is calcium hypochlorite. Suitable EVAs with 40% vinyl acetate are Arkema Evatane 4055, Dupont Elvax 40W, or Celanese 4030AC.

In some embodiments, release of the guest substrate from the one or more matrices is diffusion limited. Thus, the size and quantity of apertures within the shell polymer can be used to achieve and control the rate at which the guest substrate is diffused from the one or more matrices and the apparatus. As such, the aperture to aperture spacing and/or aperture diameter can be used to achieve and control the rate at which the guest substrate is diffused from the one or more matrices and the apparatus. Generally, the aperture size should be larger than the mean particle size of the guest substrate material in the matrix.

In some embodiments, the apparatus has a distance between apertures that is greater than or equal to half the thickness of the insoluble host/guest substrate matrix material. In other embodiments, the apparatus has a distance between apertures that is greater than or equal to the thickness of the matrix. In some embodiments, each aperture has a diameter that is less than or equal to twice the thickness of the matrix. In other embodiments, each aperture has a diameter that is less than or equal to the thickness of the matrix. In other embodiments, each aperture has a diameter that is less than or equal to two thirds (⅔) the thickness of the matrix.

In some embodiments, each matrix has a mean particle size, and wherein the mean particle size is between 1 and 2000 microns. In other embodiments, the mean particle size is between 10 and 150 microns. In some embodiments, the mean particle size is between 500 and 1000 microns. In other embodiments, the concentration of the guest substrate in the aqueous medium that exits the apparatus can be increased by increasing the mean particle size of the matrix.

In some embodiments, the rate of release of the halogen compound is controlled, at least partially, through choice of the halogen compound, the water-insoluble host material (e.g., the polymer), the halogen compound to water-insoluble host material ratio, and/or the size of the halogen compound particles. In some embodiments, the rate of release of the halogen compound is controlled, at least partially, by the degree of the homogeneity of the resulting matrix comprising the halogen compound and the water-insoluble host material. In certain embodiments, the resulting matrix is more than 10% halogen compound by weight, but less than 90% halogen compound source by weight.

In some embodiments, the halogen compound is a liquid. In other embodiments, the halogen compound is a solid. In some embodiments, the halogen compound or its reaction product is filtered at a subsequent stage, after being dissolved in water. In other embodiments, the halogen compound or its reaction product is not filtered at a subsequent stage, after being dissolved in water. In some embodiments, the halogen compound can be ingested by humans.

As noted, release from the matrix of the guest substrate, such as the disinfection compound particles, occurs by water driven dissolution of the guest substrate, resulting in a three dimensional network of open channels in the one or more matrices. In some embodiments, the three dimensional network of open channels can also be formed by the inclusion of a sacrificial (i.e., water-soluble) component within the one or more matrices. This sacrificial component could be gas bubbles introduced in the one or more matrices during the fabrication process to alter the three dimensional channel structure and promote additional release of the guest substrate, such as the disinfection compound. In some embodiments, an inert gas such as nitrogen or argon would be used avoid any degradation of the matrix or guest substrate. Thus, in some embodiments, each matrix further comprises pre-formed pores. In other embodiments, the pre-formed pores comprise air, argon, CO₂, or N₂. In some embodiments, the sacrificial component is a salt or sugar that dissolves with the guest substrate to create additional channels in the matrix. In some embodiments, the sacrificial component has equal or greater solubility in water than the guest substrate, such as the disinfection compound, to be released from the matrix. In some embodiments, the guest substrate is water-soluble, water-erodible, or a combination thereof.

In some embodiments, the one or more matrices comprise a polymer. In other embodiments, the one or more matrices comprise a material selected from the group consisting of calcium carbonate, a wax, carbohydrate, cellulose, or hydrogel.

In some embodiments, the guest substrate comprises a material selected from the group consisting of a polymer, calcium carbonate, a wax, carbohydrate, cellulose, or hydrogel. In some embodiments, the guest substrate further comprises between 1-99 wt % of one or more additives. In other embodiments, the one or more additives are selected from the group consisting of calcium carbonate, a wax, cellulose, hydrogel, salt, polysaccharide, vitamin, mineral, flavoring, herbal extract, and pharmaceutical. In some embodiments, the one or more additives comprises a vitamin. In other embodiments, the one or more additives comprises a pharmaceutical.

In another aspect is provided an apparatus that does not comprises a disinfectant compound. In such an aspect, an apparatus is provided comprising one or more matrices contained within a shell, wherein the one or more matrices comprise between 1-99 wt % of a water-insoluble host material and between 1-99 wt % of a guest substrate, wherein the guest substrate comprises between 1-100 wt % of one or more additives; and wherein the shell comprises a water-insoluble shell polymer, and one or more apertures.

In some embodiments, the one or more additives are selected from a vitamin, mineral, flavoring, herbal extract, or pharmaceutical. In some embodiments, the one or more additives comprises a vitamin. In one embodiment, the apparatus is used to fortify water with vitamins and minerals to a desired concentration such as the levels generally found in fortified foods such as cereals and breads. In other embodiments, the one or more additives comprises a pharmaceutical.

In some embodiments, the apparatus is integrated into a cartridge filter, or filtration stage in a water filtration system, or a filtration system. Generally, the filter or filtration system will maintain adequate beneficial compound levels by the control of water flow through the apparatus and/or the residence time of the apparatus within the treated water.

In some embodiments, the apparatus is a point-of-use apparatus. In some embodiments, the apparatus is used in a consumer appliance. In some embodiments, the apparatus is a water filtration apparatus. In some embodiments, the apparatus is a point-of-use water filtration apparatus. In some embodiments, the apparatus forms a tablet, capsule, hemisphere, cartridge, disk, or sheet which controllably releases the guest substrate, such as the disinfection compound, to disinfect the water over time. For example, the apparatus may be a disk or sheet with a grid of apertures, either of which can be installed as a cartridge within a system that includes one or more cartridges. In some embodiments, such a system includes multiple cartridges, one or more of which include a disinfection compound, and one or more of which do not include a disinfection compound (e.g., filtration stage, flavoring stage, coloring stage). A sheet, for example, could be rolled and implemented into one such cartridge much like blueprints when they are rolled into tubes for shipment. In one embodiment, the apertures would face the open interior of the tube to maximize potential interaction of the apertures with the water and facilitate chemical release. In some embodiments, systems have multiple cartridges (i.e., stages), in which the first and/or last cartridge of the system (i.e., the first or last stage) that contacts the water includes a disinfection compound. Including a disinfection compound within the first stage gives the disinfection compound the most time to perform its function prior to removal or neutralization by a subsequent (e.g., a filtration) stage of the system. In some embodiments, this controlled release disinfection media could be present on the first of a multi-cartridge system such that it is released into the filling reservoir while water is added to maximize the potential contact time and promote mixing. In some embodiments, this controlled release disinfection media could be present on the last of a multi-cartridge system such that a residual level of disinfection is achieved.

In some embodiments, one of the cartridges includes a filter. In some embodiments, one of the cartridges includes an additive such as a vitamin. In some embodiments, the apparatus is configured to allow the additives to be released into the water without uptake by the filter.

For example, many organic compounds are removed by activated carbon. If additives such as a vitamins are to be introduced, it would be advantageous to introduce them after the activated carbon stage in the filter, or at the last stage so that there is no interference or uptake of the additive by the filter. In contrast, for some materials it may be advantageous to reduce the parent compound or active disinfection compound prior to consumption. For example, upon the addition of iodine or an iodide salt for disinfection, an activated carbon filtration stage should be placed downstream of the iodine/iodide release to reduce iodine/iodide concentrations to sufficiently low levels that are compatible with human consumption, such as from about 0.1 mg/L to about 4 mg/L, or from about 0.5 mg/L to about 1 mg/L.

In some embodiments, additives such as flavors, vitamins, nutrients, etc., are incorporated into the apparatus such that they are not removed by the filter stage. In some embodiments, this is accomplished by the proper selection of media. In other embodiments, the additives are introduced in the last stage of the filtration system apparatus. In some embodiments, the additives (flavors, vitamins, nutrients, minerals, etc.) are introduced in a controlled-release form after the water passes through the filter system, in a reservoir or its equivalent.

At times, the apparatus may dry out and may need to be rehydrated (i.e., restart capability). In some embodiments, the apparatus will dry out and be restarted, but continue to release chemical additives at a constant rate. Without being bound to any particular theory, it is believed that as the rigid and soluble guest matrix is removed (e.g., as it dissipates from the host matrix), the resulting channels in the host matrix become substantially filled with water. Upon drying, such as when the apparatus is not used for an extended period, the water substantially evaporates from the channels and the host matrix polymer framework becomes more prone to collapse. As the host matrix framework collapses, the channels within the matrix close or narrow. Reopening of these channels upon rehydration may be a slow process. As such, the rates of release for chemical additives within the host matrix tend to decrease after the apparatus dries out. Two non-limiting approaches to improve the restart capability of the apparatus include (1) preventing the drying process by keeping the apparatus wet and (2) improving the mechanical rigidity of the host matrix to decrease channel collapse and closure.

In some embodiments, higher modulus polymer materials are used to improve the restart capability of the apparatus. In some embodiments, the higher modulus polymer is EVA with lower vinyl acetate fractions (below 40%). In other embodiments, the higher modulus polymer is polyethylene.

In other embodiments, matrices having reduced quantities of either the disinfectant compound or the beneficial compound are used to improve the restart capability of the apparatus. Matrices having reduced quantities of the disinfectant compound or the beneficial compound would result in a larger polymer volume fraction and, thus, less change in the polymer volume upon dissolution of the disinfectant compound or the beneficial compound.

In other embodiments, matrices can have water insoluble second phases added to the matrix to form a composite material which is more rigid than the original matrix host material. This resulting composite material may have better mechanical rigidity upon dissolution of the water soluble guest substrate and thus improve the restart capability of the apparatus. Non-limiting examples of more rigid materials include inorganic materials such as calcium carbonate, glass fibers, or higher modulus polymer inclusions. In some embodiments, the higher modulus polymer is EVA with lower vinyl acetate fractions (below 40%). In other embodiments, the higher modulus polymer is polyethylene.

In some embodiments, coating of the apertures with a hydrophilic polymer such as a hydrogel or polyhydroxyethylmethacrylate is used to improve the restart capability of the apparatus. This coating retains water and reduces the tendency of the matrix to dry out, thus preserving release rates. In some embodiments, this coating can be applied after formation of the matrix, shell polymer, and the apertures. In another embodiment, the apparatus would have at least two different sizes of apertures present to control restart release. For example, a few large apertures would provide an initial burst, with long term release being dominated by more numerous and smaller apertures, and with the end result being a constant release over time.

In other embodiments, the apparatus can be located in an aqueous environment that would prevent the apparatus from drying out. Alternatively, the apertures can be designed maximize water intake, catch water droplets, or by placing a membrane or film over the apertures which could trap an amount of water by capillary force between the matrices and the membrane or film. In some embodiments, the matrices are used with a sponge which retains moisture and draws out some of the guest substrate, such as the disinfectant compound or the beneficial compound, for release. In other embodiments, the apparatus could be placed in a cell which maintains a humidified environment.

Fabrication of the Apparatus

The apparatus, and the one or more matrices therein, can be fabricated by standard polymer fabrication approaches. One of the main advantages of this approach is the ability to create a limitless number of apparatus shapes (e.g., form factors) by standard polymer fabrication approaches, which can exhibit controlled release of the guest substrate, such as a disinfection compound or other additive.

In certain embodiments, the apparatus, and the one or more matrices therein, can be injection molded, extruded, sintered, or cast. For injection molding, streams of polymer and the guest substrate can be mixed in a hopper, or can be introduced as separate feed streams. Degradation of the guest substrate, such as a disinfection compound or other additive, may be a concern since many such disinfection compounds and additives, such as vitamins or pharmaceuticals are temperature sensitive and prone to degradation. In certain embodiments, guest substrates comprising calcium hypochlorite were fabricated at temperatures below about 150° C., or below about 120° C., to avoid substantial breakdown of the calcium hypochlorite.

Thus, in fabrication processes comprising temperature-sensitive guest substrates, it is advantageous to lower the fabrication times at elevated temperatures. For injection molding, this could be done by introducing the temperature-sensitive guest substrate just prior to the injection molding operation, near the mold to minimize the time at high temperature, thus reducing the residence time at high temperature in the screw. In such applications, it is also beneficial to use short cycle times of less than 10 minutes at high temperatures. In certain embodiments, lower melting-point polymers are used to reduce the required process temperature. Other fabrication processes could be used instead of molding or extrusion which employ lower temperatures or can be conducted at room temperature, such as pressing operations of the one or more matrices and the guest substrate in molds, or the casting of one or more matrices and the guest substrate, dissolved in a solvent, followed by evaporation of the solvent. For example, an EVA polymer with 40% VA fraction can be dissolved in dichloromethane, followed by an addition of the guest substrate, the resultant mixture can be cast, and solvent removed by evaporation. In certain embodiments, the resulting matrix comprising the polymer and the guest substrate is homogeneous. Other materials can optionally be added to the matrix, such as an epoxy or polyurethane to lower the processing temperatures below about 150° C. or below about 120° C.

In certain embodiments, during the fabrication processes, a quenching step may be used to cool the one or more matrices. In some embodiments, the quenching step is carefully controlled. In certain embodiments, the quenching step includes water baths saturated with the guest substrate such that no additional dissolution of the guest substrate will occur from the one or more matrices, or the quenching bath could utilize a solvent such a suitable alcohol in which neither the polymer nor guest substrate are appreciably soluble.

In certain embodiments, the shell polymer is made by standard techniques such as injection molding, dip coating, spray coating, or screen printing, lamination, etc. In some embodiments, the shell polymer is continuous, has poor water solubility, limits water and source material diffusion, and is substantially free of pinholes or other manufacturing defects. The shell polymer can be applied as a continuous sheet or can have apertures patterned through a mask during the coating application process. The shell polymer can be pre-patterned with apertures and laminated onto the matrix. If a continuous coating of the shell polymer is applied, the apertures can be fabricated afterwards by mechanical means such as grinding, drilling, punching, laser oblation, or dissolution with a suitable solvent after patterning of a suitable mask. In certain embodiments, the matrices are fabricated by injection molding in a single process, by use of a two-step mold. In the first step, the one or more matrices with guest substrate could be fabricated in the mold to the desired shape such as a disk or sheet. In the second step, pins are pressed against the surface of the one or more matrices. The rest of the mold could, for example, partially retract, leaving the pins in place to define the apertures while the shell polymer coating is injection molded from polymer material devoid of guest substrate. The partial refraction distance in the second step would define the shell polymer coating thickness. Completion of this process would result in an apparatus comprising one or more matrices contained within a shell polymer having apertures.

### Methods of Use

Another aspect provides a method of treating an aqueous medium with one or more disinfectant compounds or with one or more beneficial compounds, the method comprising: contacting the apparatus of any one of the above embodiments with the aqueous medium; and allowing the one or more disinfectant compounds or one or more beneficial compounds to diffuse into the aqueous medium, thereby increasing the concentration of the one or more disinfectant compounds or one or more beneficial compounds in the aqueous medium. In some embodiments, the aqueous medium comprises drinking water.

In some embodiments, the wt % of the one or more disinfectant compounds or one or more beneficial compounds within the apparatus decreases over time upon contact of the apparatus with the aqueous medium.

In some embodiments, the one or more disinfectant compounds or one or more beneficial compounds diffuse into the aqueous medium at a controlled rate. In other embodiments, the rate of diffusion of the one or more disinfectant compounds or one or more beneficial compounds is controlled by the number of apertures, and/or the diameter of the apertures, and/or the particle size of the one or more matrices, and/or the weight percent of the guest substrate in the insoluble host material.

In some embodiments, the controlled rate is 0.2 mg/L to 10 mg/L per minute per apparatus. In other embodiments, the controlled rate is 0.4 mg/L to 5 mg/L per minute per apparatus.

The one or more disinfectant compounds can be used to actively disinfect the water and kill all types of pathogens from viruses to bacteria to cysts by controlled release of a disinfection compound. In some embodiments, the one or more disinfectant compounds may be combined with additional approaches to control pathogens such as membrane filtration, antibacterial coatings and surfaces, or UV disinfection to provide a multi-faceted disinfectant strategy to eliminate cysts which are resistant to chlorination.

In some embodiments, the one or more disinfectant compounds destroy viruses, bacteria, cysts, or combinations thereof. In other embodiments, the viruses, bacteria, or cysts are selected from the group consisting of Escherichia coli, polio virus, rotavirus, bacteriophage f₂, Giardia lamblia cysts, Giardia muris cysts, and Cryptosporidium parvum.

Disinfection efficacy is predicted by CT products, where C is the concentration of free halogen (such as free chlorine in mg/L) and T is the contact time in min. The EPA publishes guidelines for pathogen disinfection for different CT products and pathogens (US EPA, Guidance manual for compliance with the filtration and disinfection requirements for public water systems using surface water systems, 1989).

Provided herein are methods for the controlled release of potentially dangerous disinfectant compounds in a prescribed dosage range over the lifetime of the apparatus. Too low a concentration of disinfectant compounds can result in incomplete disinfection, while too much of the disinfectant compound can result in unacceptable tastes, odors, or toxicities. Typically, for free chlorine, desired levels are in the range of about 0.2 mg/L to 10 mg/L, or about 0.5 mg/L to 4 mg/L. When contacted by such levels of free chlorine, the majority of viruses and bacteria are inactivated to 4 log (99.99% reduction) in less than 10 minutes at room temperature according to the above EPA guidelines. Thus, in certain embodiments, the apparatus will properly disinfect water by the controlled release of milligrams per liter of chlorine over a suitable contact time.

In other embodiments, higher levels (i.e., a shock) of chlorine in treated water are achieved to initially kill the pathogens before the chlorine level can be reduced. Such an approach would allow initial killing of pathogens, followed by a lower levels of residual chlorine to minimize the probability of recontamination.

In some embodiments, the method has a disinfection efficacy (CT) of between 0.01 and 20 [(mg/L)min] for a minimum of 1 log reduction (90%). In other embodiments, the method has a disinfection efficacy (CT) of between 0.01 and 5 [(mg/L)min] for a minimum of 1 log reduction (90%). In some embodiments, the disinfection efficacy (CT) is quantified at a temperature of between 5° C. and 25° C.

### Disaster Relief

In certain embodiments, the apparatus can be used for disaster relief. For example, the apparatus, or just the one or more matrices, can be introduced into water in buckets, held for a prescribed contact time, and then removed. This would allow a prescribed dosing of disinfectant and/or one or more beneficial compounds without the need for chemical measurement, or transport of concentrated chemicals. In such an application, for example, time measurement in a suitable bucket volume would be sufficient to achieve a given concentration of disinfectant and/or one or more beneficial compounds. The apparatus, or just the one or more matrices, can be used as pellets in a mesh-like sock or a stick. In certain embodiments, a warning system can be used to alert the user when the media is spent and no longer has the appropriate disinfection efficacy. This can be accomplished through proper choice of the one or more matrices and the appropriate weight fraction of disinfection compound and/or one or more beneficial compounds. For example, solid materials generally have densities greater than water. By choosing a matrix polymer with a density less than water, and appropriate weight fraction of source material, an alert system can be created. This system will exhibit an average density greater than water and sink in water when fully loaded with guest substrate (e.g., disinfectant and/or one or more beneficial compounds), but will be less dense than water and float to the surface after it has been suitably depleted of disinfectant and/or one or more beneficial compounds. This sink vs. float approach is an effective method to alert the user that the apparatus is spent of disinfectant and/or one or more beneficial compounds and should no longer be used. A similar approach could be used for other guest substrate additives such as vitamins for use in developing areas.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The present technology, thus generally described, will be understood more readily by reference to the following Examples, which are provided by way of illustration and are not intended to be limiting of the present technology.

### Examples

### Example 1

### Non-Constant and Diffusion-Limited Release of Chlorine

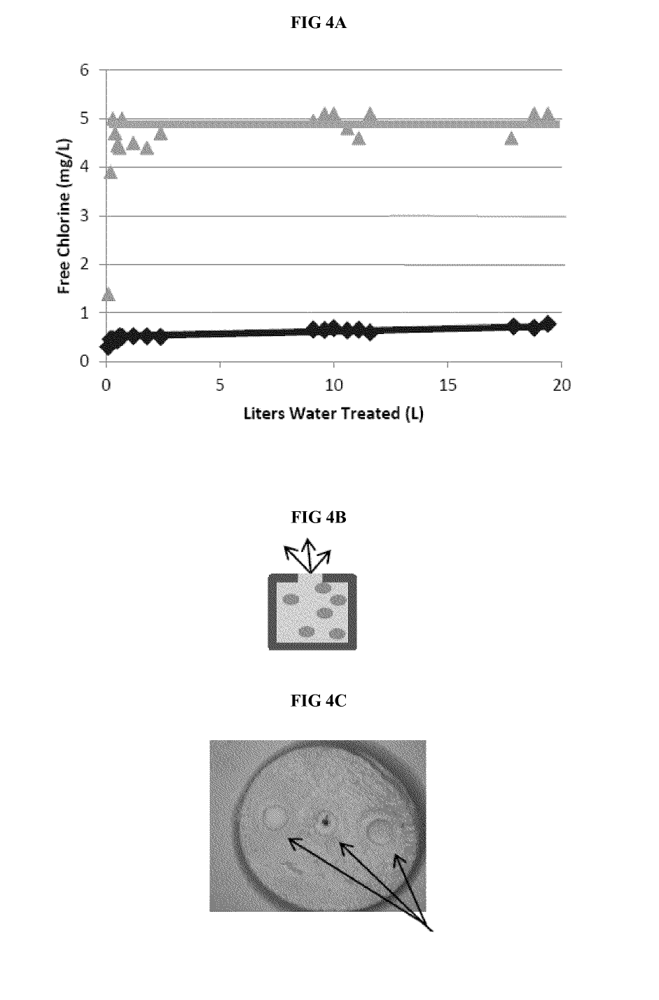

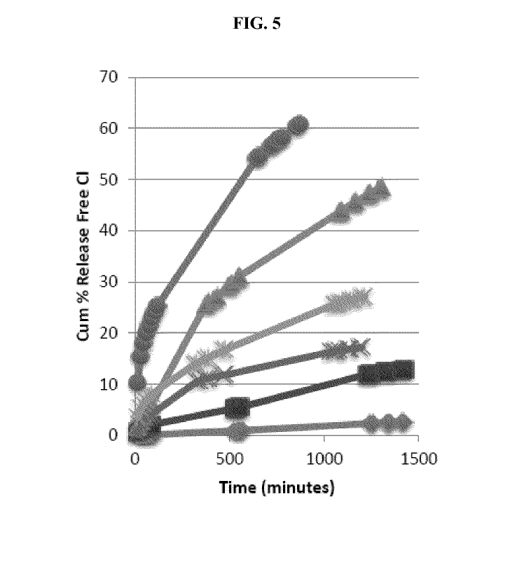

Matrices were fabricated using EVA and calcium hypochlorite, but without a shell polymer and apertures. These polymers demonstrated non constant, diffusion-limited release of the guest substrate. As shown in FIG. 3A, and illustrated in FIG. 3B, the release of guest substrate molecules from such matrices decays rapidly by the decrease of free chlorine (from calcium hypochlorite) released versus exposure to water.

### Example 2

### Constant and Controlled-Release of Chlorine

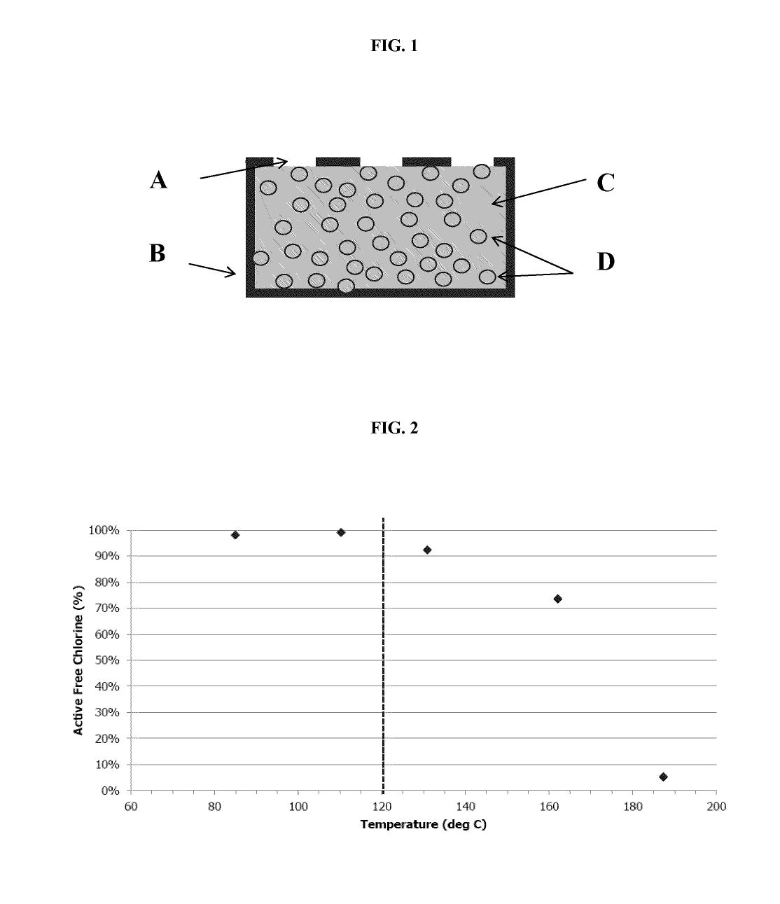

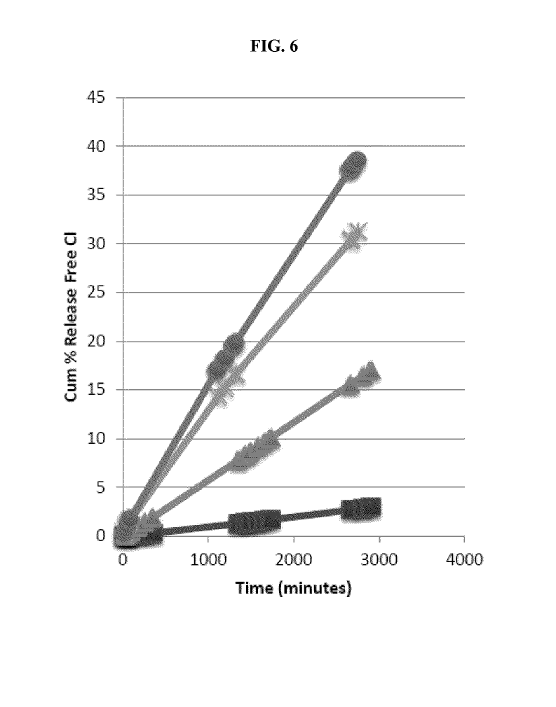

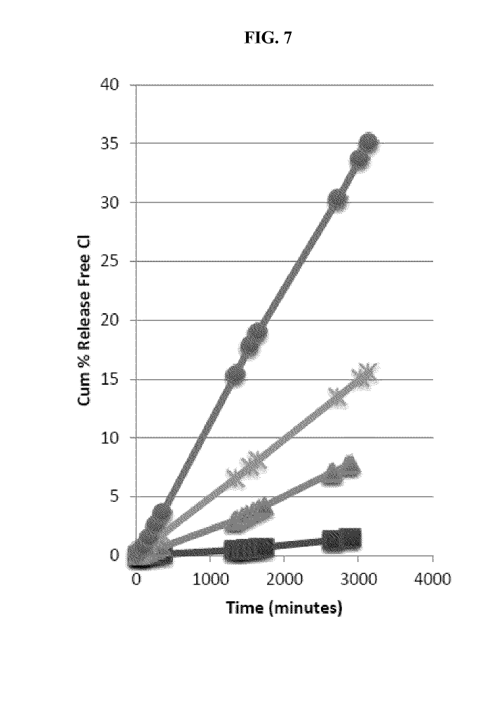

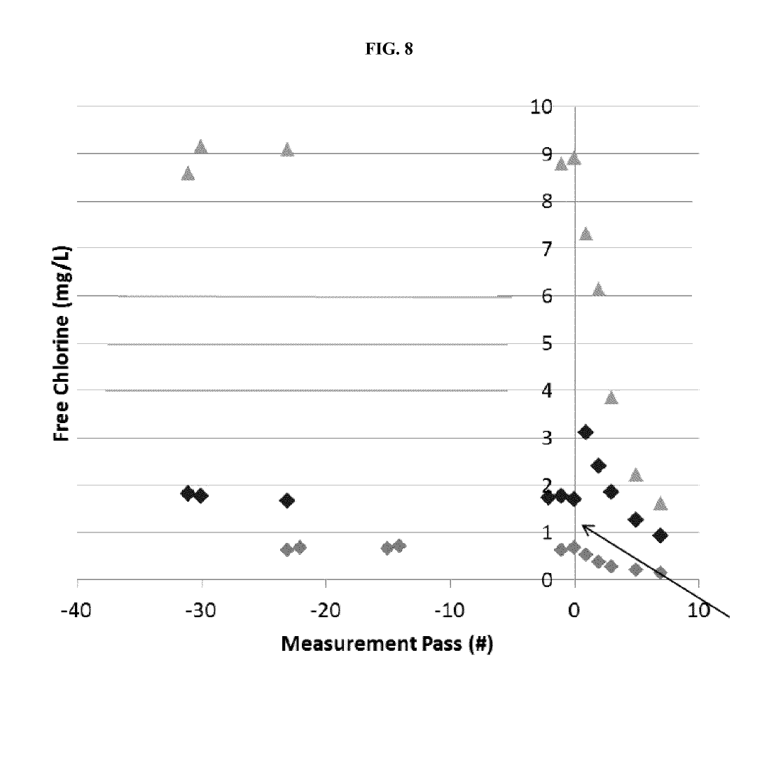

Constant release versus water exposure was achieved by deposition of a shell polymer with apertures around the matrices. As shown in FIG. 4A, and illustrated in FIGS. 1 & 4B, the release of guest substrate from matrices that were coated by a shell polymer having apertures resulted in the constant release of free chlorine (from calcium hypochlorite) versus exposure to water. The apertures in the shell polymer allow constant release of the guest substrate. Shown in FIG. 4C is an apparatus having three apertures. In FIG. 4C the aperture diameter is from between 2.5 to 2.8 mm, the aperture to aperture spacing (center to center) is between 3.2 to 3.5 mm, and the aperture pitch is between 5.7 and 6.3 mm.

### Example 3

### Blank Film Data: Non-Constant and Diffusion-Limited Release of Chlorine

The non-constant and diffusion-limited release of calcium hypochlorite by six matrices is shown in FIG. 5. Two different calcium hypochlorite chlorine source particle sizes (less than 105 microns, and between 500 to 1000 microns) and three weight fractions (40%, 60%, and 80%) were used in an EVA matrix. Release of calcium hypochlorite was non-constant for all six matrices as indicated by the curved line over the testing time.

### Example 4

### Aperture Data: Constant and Controlled-Release of Chlorine

The controlled release of calcium hypochlorite by four matrices is shown in FIG. 6 (triple aperture) and FIG. 7 (single aperture). In both cases, two different calcium hypochlorite chlorine source particle sizes (less than 105 microns, and between 500 to 1000 microns) and two weight fractions (60% and 80%) were used in an EVA matrix surrounded by shell polymers having apertures. All samples had shell polymers with three apertures. Release of calcium hypochlorite was constant for all four matrices as indicated by the straight line over the testing time. Release can be further controlled by adjusting the appropriate number of apertures in the finished device. Larger particle sizes and greater particle size distributions of calcium hypochlorite resulted in higher release rates. Smaller particle sizes and tighter particle size distributions of calcium hypochlorite resulted in more controlled release, with particle size distributions, for example, of less than 500 microns maximum to minimum. In some instances, the matrices were not used to complete exhaustion of the calcium hypochlorite, but were exhausted when about 25% of the calcium hypochlorite still remained in the matrices. In the above FIGS. 7 & 8, the maximum exhaustion was obtained when about 40% of the calcium hypochlorite still remained in the matrices.

### Example 5

### Restart Data

An apparatus was prepared having matrices containing calcium hypochlorite and a polymer shell with apertures as illustrated in FIG. 1. The apparatus was tested for release of the calcium hypochlorite every 15 minutes and then the apparatus was dried out in a desiccator for one week. After drying, the apparatus was tested again for release every 15 minutes and the data was plotted as shown in FIG. 8. In FIG. 8, the drying is indicated as measurement pass=0. Consistent and constant release was achieved prior to drying as indicated in release data plotted with negative measurement passes, and lower release levels were achieved after drying for measurement passes >0.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. An apparatus comprising one or more matrices contained within a shell,
wherein the one or more matrices comprise:
between 1-99 wt % of a water-insoluble host material; and
between 1-99 wt % of a guest substrate,
wherein the guest substrate comprises between 1-100 wt % of one or more disinfectant compounds; and
wherein the shell comprises a water-insoluble shell polymer, and one or more apertures.

2. The apparatus of claim 1, wherein each matrix comprises between 10 wt % and 90 wt % of the guest substrate, and the guest substrate comprises between 1% to 100% of one or more disinfectant compounds.

3. The apparatus of claim 1, wherein each matrix comprises between 40 wt % and 80 wt % of the guest substrate, and the guest substrate comprises between 1% to 100% of one or more disinfectant compounds.

4. The apparatus of any one of claims 1-3, wherein the one or more disinfectant compounds comprise a halogen source compound.

5. The apparatus of claim 4, wherein the halogen source compound is selected from the group consisting of calcium hypochlorite, sodium hypochlorite, trichloroisocyanuric acid, sodium dichloroisocyanurate, 1,3-dibromo-5,5-dimethylhydantoin (DBDMH), 1-bromo-3-chloro-5,5-dimethylimidazolidine-2,4-dione (BCDMH), and potassium iodide.

6. The apparatus of claim 5, wherein the halogen source compound is calcium hypochlorite.

7. An apparatus comprising one or more matrices contained within a shell,
wherein the one or more matrices comprise:
between 1-99 wt % of a water-insoluble host material; and
between 1-99 wt % of a guest substrate,
wherein the guest substrate comprises between 1-100 wt % of one or more beneficial compounds; and
wherein the shell comprises a water-insoluble shell polymer, and one or more apertures.

8. The apparatus of claim 7, wherein the one or more beneficial compounds comprises a vitamin.

9. The apparatus of claim 7, wherein the one or more beneficial compounds comprises a pharmaceutical.

10. The apparatus of claim 7, wherein the one or more beneficial compounds comprises a mineral.

11. The apparatus of any one of claims 1-10, wherein the host material is a host polymer.

12. The apparatus of any one of claims 1-10, wherein the host material is calcium carbonate.

13. The apparatus of any one of claims 1-12, further comprising an aqueous medium.

14. The apparatus of claim 13, wherein the aqueous medium enters the apparatus through the one or more apertures, contacts the one or more matrices, and exits the apparatus through the one or more apertures.

15. The apparatus of any one of claims 1-14, wherein the aqueous medium that exits the apparatus comprises the guest substrate at a concentration of between 0.0001 mg/L and 500 mg/L.

16. The apparatus of any one of claims 1-15, wherein the concentration of the guest substrate in the aqueous medium that exits the apparatus can be controlled by the quantity and/or the diameter of the one or more apertures.

17. The apparatus of any one of claims 1-16, wherein the aqueous medium that exits the apparatus comprises either the disinfectant compound or the beneficial compound at a concentration of between 0.2 mg/L and 10 mg/L.

18. The apparatus of claim 17, wherein the aqueous medium that exits the apparatus comprises either the disinfectant compound or the beneficial compound at a concentration of between 0.5 mg/L and 4 mg/L.

19. The apparatus of any one of claims 1-18, wherein the one or more apertures are sealed with a hydrophilic polymer.

20. The apparatus of claim 19, wherein the hydrophilic polymer comprises a hydrogel.

21. The apparatus of claim 20, wherein the hydrogel is polyhydroxyethylmethacrylate.

22. The apparatus of any one of claim 1-11 or 13-21, wherein the host polymer and the shell polymer are independently selected from ethylene vinyl acetate (EVA), polyvinyl alcohol, silicone rubber, polyethylene, polypropylene, polystyrene (PS), polyester (PE), and copolymers thereof.

23. The apparatus of claim 22, wherein the host polymer and the shell polymer are the same.

24. The apparatus of claim 22, wherein the host polymer and the shell polymer are different.

25. The apparatus of claim 22, wherein the host polymer and the shell polymer are injection moldable.

26. The apparatus of claim 22, wherein the host polymer comprises ethylene vinyl acetate (EVA).

27. The apparatus of claim 22, wherein the shell polymer comprises ethylene vinyl acetate (EVA).

28. The apparatus of claim 26 or claim 27, wherein the ethylene vinyl acetate (EVA) is Celanese 4030AC, Arkema Evatane 4055, or DuPont Elvax 40W.

29. The apparatus of any one of claims 1-28, wherein the shell has a thickness of between 1 and 500 microns.

30. The apparatus of claim 29, wherein the shell has a thickness of between 1 and 100 microns.

31. The apparatus of any one of claims 1-30, wherein each matrix is homogenous.

32. The apparatus of any one of claims 1-31, wherein each matrix has a mean particle size, and wherein the mean particle size is between 1 and 2000 microns.

33. The apparatus of claim 32, wherein the mean particle size is between 500 and 1000 microns.

34. The apparatus of claim 32, wherein the mean particle size is between 10 and 150 microns.

35. The apparatus of any one of claims 1-34, having a distance between apertures that is greater than or equal to half the thickness of the matrix.

36. The apparatus of claim 35, having a distance between apertures that is greater than or equal to the thickness of the matrix.

37. The apparatus of any one of claims 1-36, wherein each aperture has a diameter that is less than or equal to twice the thickness of the matrix.

38. The apparatus of claim 37, wherein each aperture has a diameter that is less than or equal to the thickness of the matrix.

39. The apparatus of any one of claims 1-38, wherein the concentration of the guest substrate in the aqueous medium that exits the apparatus can be increased by increasing the mean particle size of the matrix.

40. The apparatus of any one of claims 1-39, wherein each matrix further comprises pores.

41. The apparatus of claim 40, wherein the pores comprise air, argon, CO₂, or N₂.

42. The apparatus of any one of claims 1-41, wherein the guest substrate is water-soluble, water-erodible, or a combination thereof.

43. The apparatus of any one of claims 1-42, wherein the guest substrate further comprises between 1-99 wt % of one or more additives.

44. The apparatus of claim 43, wherein the one or more additives are selected from the group consisting of a wax, cellulose, hydrogel, salt, polysaccharide, vitamin, flavoring, herbal extract, and pharmaceutical.

45. The apparatus of claim 44, wherein the one or more additives comprises a vitamin.

46. The apparatus of claim 44, wherein the one or more additives comprises a pharmaceutical.

47. The apparatus of any one of claims 1-46, wherein the apparatus is a cartridge, sheet, or disk.

48. The apparatus of any one of claims 1-47, wherein the apparatus is a point-of-use apparatus.

49. The apparatus of any one of claims 1-48, wherein the apparatus is used in a consumer appliance.

50. The apparatus of claim 49, wherein the consumer appliance is a water filtration apparatus.

51. A method of treating an aqueous medium with either one or more disinfectant compounds or one or more beneficial compounds, the method comprising:
contacting the apparatus of any one of claims 1-50 with the aqueous medium; and
allowing the one or more disinfectant compounds or one or more beneficial compounds to diffuse into the aqueous medium, thereby increasing the concentration of the one or more disinfectant compounds or one or more beneficial compounds in the aqueous medium.

52. The method of claim 51, wherein the aqueous medium comprises drinking water.

53. The method of claim 51, wherein the wt % of the one or more disinfectant compounds or the one or more beneficial compounds within the apparatus decreases over time upon contact of the apparatus with the aqueous medium.

54. The method of claim 51, wherein the one or more disinfectant compounds or the one or more beneficial compounds diffuse into the aqueous medium at a controlled rate.

55. The method of claim 54, wherein the rate of diffusion of the one or more disinfectant compounds or the one or more beneficial compounds is controlled by the number of apertures, and/or the diameter of the apertures, and/or the particle size of the one or more matrices.

56. The method of claim 54, wherein the controlled rate is 0.2 mg/L to 10 mg/L per minute per apparatus.

57. The method of claim 54, wherein the controlled rate is 0.4 mg/L to 5 mg/L per minute per apparatus.

58. The method of claim 51, wherein the one or more disinfectant compounds destroy viruses, bacteria, cysts, or combinations thereof.

59. The method of claim 58, wherein the viruses, bacteria, or cysts are selected from the group consisting of Escherichia coli, polio virus, rotavirus, bacteriophage f₂, Giardia lamblia cysts, Giardia muris cysts, and Cryptosporidium parvum.

60. The method of claim 51, having a disinfection efficacy (CT) of between 0.01 and 20 [(mg/L)min] for a minimum of 1 log reduction (90%).

61. The method of claim 51, having a disinfection efficacy (CT) of between 0.01 and 5 [(mg/L)min] for a minimum of 1 log reduction (90%).

62. The method of claim 60 or claim 61, wherein the disinfection efficacy (CT) is quantified at a temperature of between 5° C. and 25° C.
